(19) United States
(12) Patent Application Publication
(10) Pub. No.: US 2023/0308284 A1
(43) Pub. Date: Sep. 28, 2023

(54) SYSTEMS FOR REMOTE SIGNING OF APPLICATIONS

(71) Applicant: HEADSPIN, INC., PALO ALTO, CA (US)

(72) Inventors: JAMES RILEY WILBURN, ARLINGTON, VA (US); SIMO ANTTI KALERVO KINNUNEN, SHIBUYA-KU (JP); JONATHAN RAFKIND, FREMONT, CA (US); BRIEN COLWELL, REDWOOD CITY, CA (US)

(21) Appl. No.: 17/656,125

(22) Filed: Mar. 23, 2022

(51) Int. Cl. H04L 9/32

(52) U.S. Cl. CPC H04L 9/3236; H04L 9/3263

(57) ABSTRACT

A first device that lacks the private cryptographic key used to generate a cryptographic signature for a component of an application is able to obtain a signature from a second device. The second device provides data indicative of a profile or certificate that is associated with a stored private key to a data store via an intermediate device that does not access the private key. The first device provides a request that indicates the profile or certificate to the data store via an intermediate device. When a match between the request and the data provided by the second device is determined, the request is sent to the second device, which generates a cryptographic signature and provides it to the first device via the intermediate devices. The first device is therefore able to obtain signatures for components of an application from a separate device that accesses the associated private key.

### BACKGROUND

Applications may access a variety of resources and other components during use. In some cases, an application must be cryptographically signed to enable the application to be installed, developed, deployed, and so forth. For example, various operating systems or platforms may require one or more components of an application to be signed prior to use to ensure that the application is associated with a user, account, or profile having appropriate permissions to develop and deploy the application. In cases where multiple users, such as individuals associated with a company or other entity, develop or test an application for which one or more components require a cryptographic signature, obtaining a potentially large number of accounts or profiles with permissions to cryptographically sign the component(s) of the application may be impractical.

### INCORPORATION BY REFERENCE

U.S. Pat. Application 14/850,798, filed Sep. 10, 2015 and titled “System for Application Test”, now U.S. Pat. 9,681,318, is hereby incorporated by reference in its entirety.

U.S. Pat. Application 15/425,757, filed Feb. 6, 2017 and titled “Mobile Device Point of Presence Infrastructure”, now U.S. Pat. 10,729,038, is hereby incorporated by reference in its entirety.

U.S. Pat. Application 15/619,181, filed Jun. 9, 2017 and titled “System for Assisting in Assessment and Mitigation of Data Network Operations”, now U.S. Pat. 11,144,441, is hereby incorporated by reference in its entirety.

U.S. Pat. Application 15/783,859, filed Oct. 13, 2017 and titled “System for Testing Using Remote Connectivity” is hereby incorporated by reference in its entirety.

U.S. Pat. Application 15/941,674, filed Mar. 30, 2018 and titled “Interactive Application Testing System Using Remote Resources” is hereby incorporated by reference in its entirety.

U.S. Pat. Application 16/056,797, filed Aug. 7, 2018 and titled “System for Controlling Transfer of Data to a Connected Device”, now U.S. Pat. 11,019,129, is hereby incorporated by reference in its entirety.

U.S. Pat. Application 17/179,136, filed Feb. 18, 2021, and titled “Systems for Remote Communication with Test Devices” is hereby incorporated by reference in its entirety.

U.S. Pat. Application 17/206,926, filed Mar. 19, 2021, and titled “Systems for Remote Determination of Data from Test Devices” is hereby incorporated by reference in its entirety.

U.S. Pat. Application 17/302,884, filed May 14, 2021, and titled “Systems for Controlling Acquisition of Test Data from Devices” is hereby incorporated by reference in its entirety.

### BRIEF DESCRIPTION OF FIGURES

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A-1C depict an implementation of a system for providing a cryptographic signature from a first device to a second device that stores one or more application components to enable the application component(s) to be cryptographically signed using the cryptographic signature.

FIGS. 2A and 2B depict an implementation of a process for providing a cryptographic signature from a first device to a second device using a signing network that receives data from the first device and second device.

FIG. 3 is a block diagram illustrating an implementation of a signing device within the present disclosure.

FIG. 4 is a block diagram illustrating an implementation of a testing device within the present disclosure.

FIG. 5 is a block diagram illustrating an implementation of a signing network device within the present disclosure.

While implementations are described in this disclosure by way of example, those skilled in the art will recognize that the implementations are not limited to the examples or figures described. It should be understood that the figures and detailed description thereto are not intended to limit implementations to the particular form disclosed but, on the contrary, the intention is to cover all modifications, equivalents, and alternatives falling within the spirit and scope as defined by the appended claims. The headings used in this disclosure are for organizational purposes only and are not meant to be used to limit the scope of the description or the claims. As used throughout this application, the word “may” is used in a permissive sense (i.e., meaning having the potential to) rather than the mandatory sense (i.e., meaning must). Similarly, the words “include”, “including”, and “includes” mean “including, but not limited to”.

### DETAILED DESCRIPTION

Various operating systems and platforms require applications, or components associated with applications (such as libraries, resources, and so forth), to be cryptographically signed before the application or component is permitted to be installed, executed, and so forth. The cryptographic signature may be used to verify that the application has not been modified by unauthorized users after signing of the application, and may therefore indicate that the application is most likely safe for installation and use. For example, a user that is authorized to develop and deploy an application may be provided with a private cryptographic key. The private key may be used in combination with public cryptographic data such as a hash or other data representing an application, a public cryptographic key, a provisioning profile, and so forth, to generate a cryptographic signature associated with a component of the application.

In cases where an application is under development or is being tested, the application may be modified in various ways, and different versions or builds of the application may be frequently installed, deployed to various devices, executed, and so forth. For example, an application may be deployed to multiple devices for the purpose of testing functions of the application under various sets of conditions. During such a process, each component of the application for which a cryptographic signature is required must be signed each time that the application is modified and deployed to a device. In some cases, a potentially large number of users may be involved in the development, testing, and deployment of an application. Providing a private cryptographic key to a large number of users to enable signing of the application by each user raises significant security concerns. However, the acquisition and maintenance of a large number of profiles that each have appropriate authorization to generate cryptographic signatures for an application using individual private keys may be impractical, and may also raise security concerns.

Described in this disclosure are techniques that enable a device that is associated with a private cryptographic key to generate cryptographic signatures for an application, or a component of the application, that is stored or accessed by a different device. Once one or more cryptographic signature(s) are available, the application may then be used, installed, or deployed to other devices. A first computing device (a “signing device”) stores or is able to access a private cryptographic key. The signing device may establish communication with a second computing device (a “host device”) that is able to access a data store. The host device and data store may be part of a signing network that includes one or more data stores and one or more computing devices that communicate with signing devices and with devices that store or access applications for which cryptographic signatures are needed. The data store associates information regarding private cryptographic keys with identifiers that indicate corresponding computing devices. For example, the first computing device may provide public cryptographic data that is associated with the private cryptographic key to the second computing device. Public cryptographic data may include or may indicate a public certificate, a provisioning profile, a public cryptographic key, or may include an indication of a private cryptographic key. Public cryptographic data may also include an indication of an application component for which the signing device may generate a cryptographic signature. The second computing device may provide this public cryptographic data to the data store, which may store the data in association with an identifier indicative of the signing device or the second computing device.

A third computing device (a “testing device”) stores or is able to access an application, or a signable component or other portion of an application (such as a library or other resource). In some cases, a testing device may not store the private key that is used to generate a cryptographic signature for the application. To obtain a cryptographic signature, the testing device may determine public cryptographic data associated with the application or component. The public cryptographic data associated with the application or component may include data indicative of a provisioning profile, public certificate, public cryptographic key, or other indication of the application or component of the application. For example, the public cryptographic data may include a hash based on one or more components of the application. This public cryptographic data may then be provided to the data store associated with the signing network. For example, the testing device may be associated with an organization that is developing or deploying the application, but may not be associated with a profile that is authorized to generate cryptographic signatures for the application. The testing device may establish communication with a fourth computing device (e.g., a host device that is part of the signing network) that is able to access the data store, and may provide a request that indicates the public cryptographic data to the fourth computing device. The fourth computing device may provide the request to the data store. A computing device associated with the data store may determine that the public cryptographic data associated with the request corresponds to the public cryptographic data received from the first computing device. For example, a certificate or profile associated with the request may match a certificate or profile indicated in the data received from the second computing device.

Based on this correspondence, the request may be provided from the data store to the second computing device, which may in turn provide the request to signing device that stores or is able to access the private cryptographic key. The signing device may determine the profile or certificate that is indicated in the request, determine the corresponding private cryptographic key, and generate a cryptographic signature based in part on the private cryptographic key. The signing device may then provide the cryptographic signature to the second computing device, which may in turn cause the cryptographic signature to be provided to the fourth computing device with which the testing device has established communication. In some implementations, the fourth computing device may determine that the cryptographic signature corresponds to the profile, certificate, or other public cryptographic data associated with the request before providing the cryptographic signature to the testing device. In other implementations, the cryptographic signature may be provided to the testing device without such analysis of the cryptographic signature using the fourth computing device. The testing device may then associate the cryptographic signature with the corresponding component of the application, generating a signed component, which may enable the application to be installed, deployed, used, and so forth.

As a result, computing devices that do not store or are not able to access a private cryptographic key may be used to develop and deploy applications having components that would normally require a cryptographic signature to install, deploy, or use. For example, an entity may maintain one or more testing devices that do not store a private key at geolocations that are remote from a signing device, and these testing devices may obtain cryptographic signatures by providing a request to a signing device associated with the private cryptographic key and receiving a cryptographic signature. In cases where numerous testing devices are used, or where one or more testing devices are not associated with the same entity, retaining the private key solely on the signing device may improve security while enabling testing devices to obtain cryptographic signatures during development and testing of an application. As such, the private cryptographic key may be retained securely in association with the signing device, such that other computing devices are not provided with access to the private cryptographic key. For example, generation of cryptographic signatures may occur on the signing device, independent of the other computing devices. The application or signable component of the application, and in some cases public cryptographic data such as a public certificate, may be stored on the testing device, which may use the received cryptographic signature to generate a signed component of the application for use. Therefore, components of the application may be signed using a cryptographic signature generated by the signing device, without transmitting the components from the testing device to other computing devices.

This process may be performed using generally “blind” or “naive” communications. For example, a first device that stores or accesses a private cryptographic key may provide data to the data store without addressing the data to any particular receiving device. Similarly, a requesting device that stores or accesses an application or a component of the application may provide a request to the data store without addressing the request to the first device or any other device. The correspondence between the data indicated in the request and the data provided by the first device may enable the request to be provided to the first device (or another device that provided data that corresponds to the request) for generation of a cryptographic signature, and for the cryptographic signature to be provided to the requesting device, without requiring knowledge of devices that are associated with the private cryptographic key or with the application. Additionally, the private key and the application components are not required to be transmitted from the signing device or testing device to other devices. For example, the computing devices that maintain and access the data store may not necessarily be affiliated with the same entities as those that utilize the testing devices and signing devices, but may coordinate communications between testing devices and signing devices, which may be at different geolocations.

In some cases, multiple devices may be capable of generating a cryptographic signature associated with an application. For example, data in the data store that is associated with multiple devices may correspond to a request received from a testing device. The testing device may provide a request to the data store by establishing communication with an intermediate device. In such a case, the request may be sent to multiple devices, each of which may generate a cryptographic signature. The signatures may be provided to the intermediate device, each cryptographic signature being created by a different device that stores a private cryptographic key that corresponds to the request. The intermediate device may provide the first cryptographic signature that is received to the requesting device. In some implementations, the intermediate device may determine that a received cryptographic signature is valid (e.g., corresponds to the certificate, profile, public key, or other data indicated in the request) before providing the cryptographic signature to the requesting device.

In some cases, one or more components of an application may depend upon one or more other components. For example, cryptographically signing a second component of an application may not be possible until a first component has been cryptographically signed. In such a case, the requesting device may provide a first request to obtain a cryptographic signature associated with the first component prior to providing a second request to obtain a cryptographic signature associated with the second component. The second request may be sent in response to receiving the cryptographic signature for the first component. In cases where a lack of dependency between components of an application (e.g., multiple components of an application do not depend on other components), the requesting device may provide multiple requests for different components of the application in parallel (e.g., within a threshold length of time of one another), and may generate signed components of the application using received cryptographic signatures as the signatures are received. For example, sending two requests within a threshold length of time of one another may include sending the requests at least partially concurrently with one another, or sending a second request for a cryptographic signature for a second component of an application before the cryptographic signature for a first request is received. After each component of an application for which a signature is required has been acquired, the receiving device may deploy, install, execute, or perform one or more other functions associated with the application.

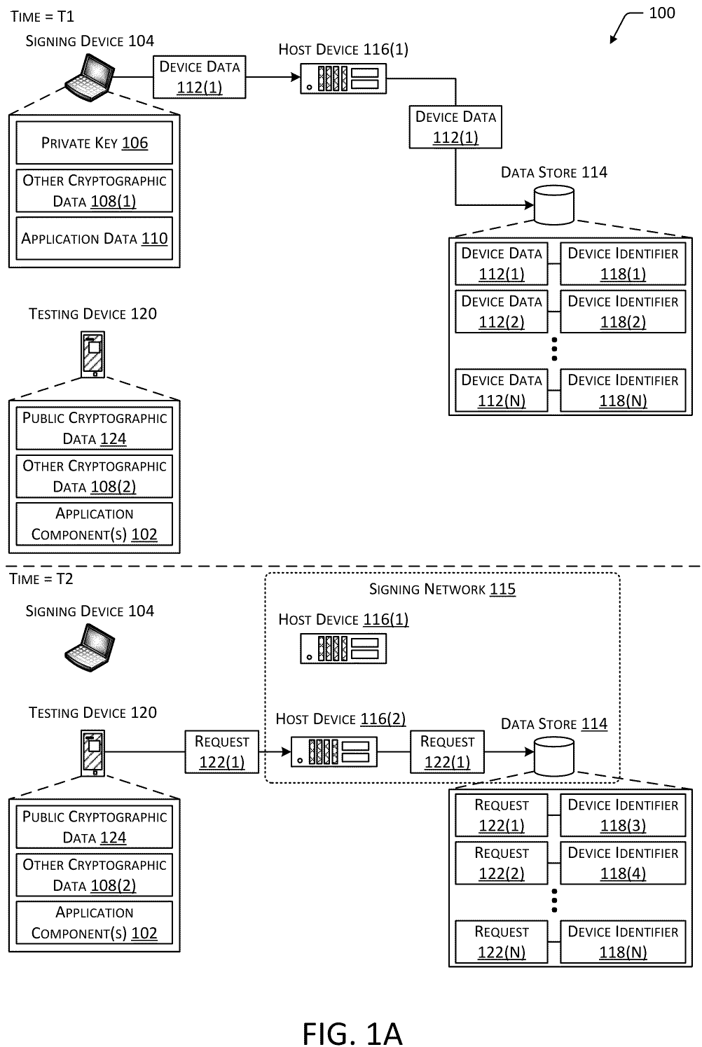

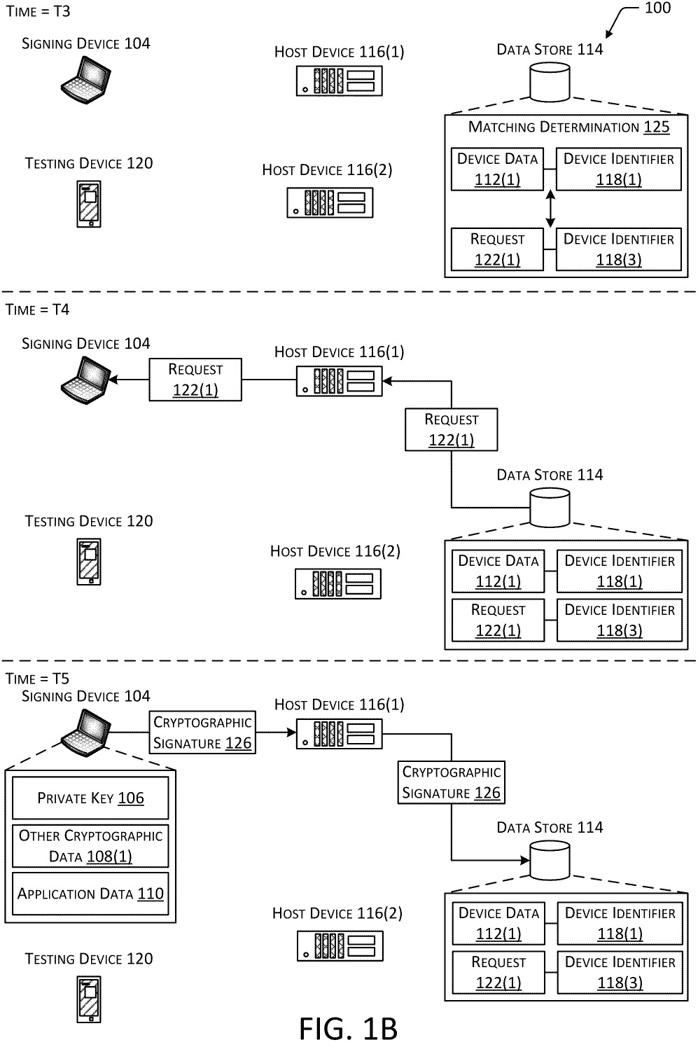

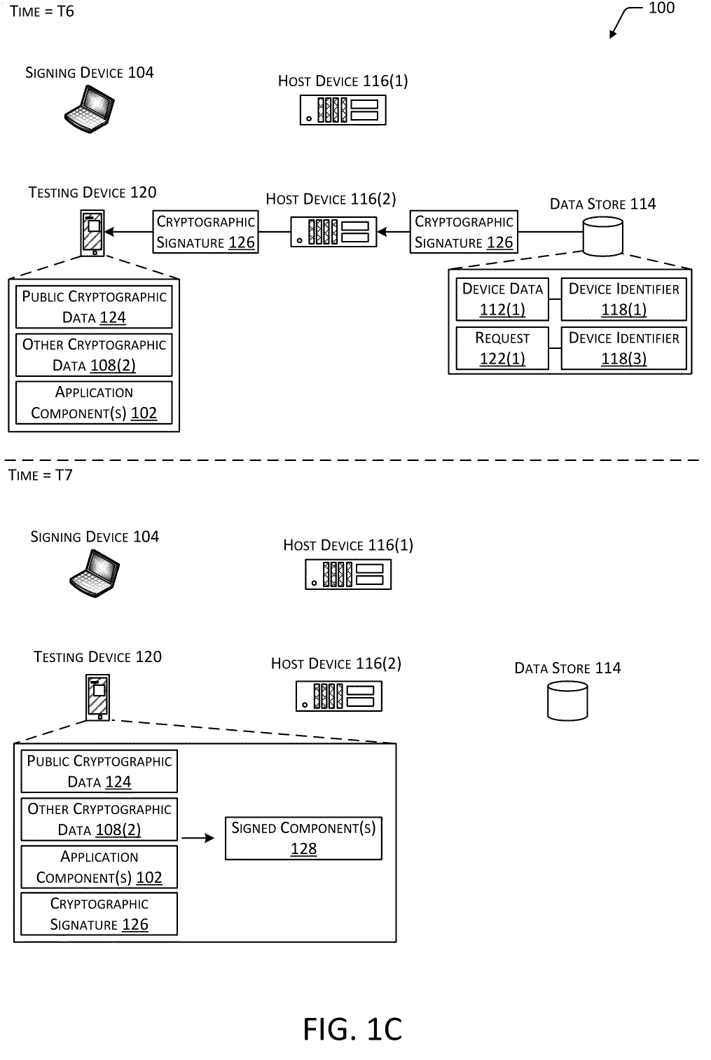

FIGS. 1A-1C depict an implementation of a system 100 for providing a cryptographic signature from a first device to a second device that stores one or more application components 102 to enable the application component(s) 102 to be cryptographically signed using the cryptographic signature. A first computing device, labeled as signing device 104, may store a private key 106 that may be used to generate cryptographic signatures. While FIGS. 1A-1C depict the signing device 104 as a personal computing device, in other implementations, the signing device 104 may include any number and any type of computing devices including one or more servers, portable computing devices, wearable computing devices, networked input or output devices, and so forth. In addition to the private key 106, the signing device 104 may store other cryptographic data 108(1), which may include or may indicate one or more certificates, public keys, profiles, user accounts, or other data that may correspond to the private key 106 or may be used in conjunction with the private key 106 to generate cryptographic signatures. In some cases, the signing device 104 may further store application data 110, which may include or may indicate of one or more applications or components of applications that are associated with the private key 106. While FIGS. 1A-1C depict the signing device 104 storing a single private key 106, in other implementations, a signing device 104 may store multiple private keys 106, or may access private keys 106 that are stored in association with other computing devices. Additionally, while FIGS. 1A-1C depict a single signing device 104, any number of signing devices 104 associated with any number of private keys 106 may interact with the system 100 in the manner described with regard to the signing device 104 shown in FIGS. 1A-1C.

To enable the signing device 104 to generate cryptographic signatures for use by other computing devices, at a first time T1, the signing device 104 may provide device data 112(1) to a data store 114 associated with a signing network 115. The device data 112(1) may include data indicative of the private key 106, and in some cases, data indicative of the other cryptographic data 108(1), application data 110, or information regarding the signing device 104. For example, the device data 112(1) may include data indicative of a public certificate, public key, provisioning profile, or other data that corresponds to the private key 106 stored by the signing device 104. To provide the device data 112(1) to the data store 114, the signing device 104 may establish communication with a host device 116(1) that is part of the signing network 115. The host device 116(1) may communicate with the data store 114. For example, the host device 116(1) may include one or more servers or other types of computing devices, including without limitation the types of computing devices described with regard to the signing device 104. The host device 116(1) may communicate with a computing device that stores, executes, or accesses the data store 114, or in other implementations, the host device 116(1) may itself store, execute, or access the data store 114. For example, the data store 114 may include an in-memory data structure store distributed across one or more computing devices that may store key values, cache and transmit messages and other communications between computing devices, and store other types of data structures such as strings, lists, maps, sets, logs, streams, indices, and so forth. As shown in FIG. 1A, the signing device 104 may provide device data 112(1) to the host device 116(1), which may in turn provide the device data 112(1), or other data indicative of the device data 112(1) to the data store 114. The data store 114 may store the device data 112(1) in association with a device identifier 118(1) that is indicative of one or more of the signing device 104 or host device 116(1).

The data store 114 may store device data 112 from multiple signing devices 104, each set of device data 112 indicating a private key 106, public certificate, provisioning profile, public key, other cryptographic data 108, or application data 110 that indicates the capabilities of a signing device 104 to generate cryptographic signatures for particular applications or application components 102. For example, the data store 114 is shown storing the device data 112(1) for the depicted signing device 104 in association with a corresponding device identifier 118(1), second device data 112(2) for a different computing device in association with a second device identifier 118(2), and any number of additional device data 112(N) in association with corresponding additional device identifiers 118(N).

A testing device 120 may store, execute, or access one or more application components 102 associated with an application. For example, a testing device 120 may be used to deploy, install, execute, or use an application, such as for the purpose of testing performance of the application, or of the testing device 120 during use of the application, under various conditions associated with the testing device 120. In other cases, the testing device 120 may be used to deploy the application, or components of the application, to other computing devices, such as to test performance of the application under conditions associated with the devices that receive the application. Continuing the example, the testing device 120, or other computing devices to which the application is deployed, may include particular hardware or software components, may access particular networks, may be located in a particular geolocation, and so forth. These differing factors may enable the effect of various device conditions or network conditions on the performance of the application or of the computing device to be determined. The testing device 120 may include a portable computing device, personal computing device, or other type of computing device including, without limitation, the types of computing devices described with regard to the signing device 104. As described previously, in many cases, a potentially large number of testing devices 120 may be used to test performance of an application or computing device under various sets of conditions, and providing a large number of testing devices 120 with a private key 106 that is usable to generate cryptographic signatures for each component of the application may be impractical or create security concerns.

To enable the testing device 120 to deploy, install, execute, or use the application, the system 100 may enable the testing device 120 to obtain a cryptographic signature for one or more application components 102 by providing a request 122(1) to the data store 114. The request 122(1) may be indicative of the private key 106 associated with an application component 102, the application component 102 itself, public cryptographic data 124 associated with the application component 102 such as an indication of a public key, public certificate, profile, and so forth. For example, the testing device 120 may store or may access other cryptographic data 108(2), which may include or indicate a public key, certificate, profile, or other data indicative of a private key 106 or of one or more application components 102, and at least a portion of this data may be indicated in the request 122(1). For example, the request 122(1) may include a hash based on one or more components of the application.

At a second time T2, to provide the request 122(1) to the data store 114, the testing device 120 may establish communication with a host device 116(2) that is part of the signing network 115. The host device 116(2) may communicate with the data store 114. In some cases, the host device 116(2) with which the testing device 120 establishes communication may be the same host device 116(1) as that with which the signing device 104 established communication. In other cases, the testing device 120 may establish communication with a different host device 116(2). Any number of host devices 116(2) may communicate with a computing device that stores or accesses the data store 114, or in some cases, the host device(s) 116 may store, execute, or access the data store 114. As shown in FIG. 1A, the testing device 120 may provide the request 122(1) to the host device 116(2) which may in turn provide the request 122(1), or data indicative of the request 122(1), to the data store 114. The data store 114 may associate the request 122(1) with a device identifier 118(3) that is indicative of one or more of the testing device 120 or the host device 116(2).

The data store 114 may receive requests 122 from multiple testing devices 120, each request 122 indicating a certificate, profile, or other indication of a private key 106, public key, other cryptographic data 108, or application component 102. For example, the data store 114 is shown associating the request 122(1) from the depicted testing device 120 with a corresponding device identifier 118(3), a second request 122(2) with an additional device identifier 118(4), and any number of additional requests 122(N) with corresponding additional device identifiers 118(N).

At a third time T3, a computing device associated with the data store 114 may determine correspondence between device data 112(1) received from a signing device 104 and a request 122(1) received from a testing device 120. For example, FIG. 1B depicts the data store 114 generating a matching determination 125 that indicates the correspondence between the device data 112(1) associated with the depicted signing device 104 and the request 122(1) associated with the depicted testing device 120. The correspondence may indicate that the signing device 104 stores or is able to access a private key 106 that corresponds to the public key, certificate, profile, application component 102, or other data indicated in the request 122(1).

At a fourth time T4, based on the correspondence between the device data 112(1) and the request 122(1), a computing device associated with the data store 114 may cause the request 122(1), or data indicative of the request 122(1) to be provided to the signing device 104. The request 122(1) or data indicative of the request 122(1) may be provided to the host device 116(1) with which the signing device 104 established communication to provide the device data 112(1) to the data store 114, or in some implementations, with a different host device 116 that is able to communicate with the signing device 104. The host device 116(1) may then provide the request 122(1) or data indicative of the request 122(1) to the signing device 104.

At a fifth time T5, the signing device 104 may determine that the private key 106 corresponds to the data indicated in the request 122(1) and generate a cryptographic signature 126 based in part on the private key 106. In some cases, the signing device 104 may not store the application or application component(s) 102 associated with the cryptographic signature 126. However, the signing device 104 may store the private key 106 associated with one or more application component(s) 102 for generation of cryptographic signatures 126 in response to requests 122 from one or more testing devices 120. The cryptographic signature 126 may be generated based at least in part on the private key 106, and in some implementations, based in part on other cryptographic data 108(1), such as one or more certificates, profiles, components of an application, and so forth. For example, the cryptographic signature 126 may be generated based on the private key 106 and data received in the request 122(1), such as a hash based on one or more application components 102. As shown in FIG. 1B, the signing device 104 may send the cryptographic signature 126 to the host device 116(1) which may in turn send the cryptographic signature 126 to the data store 114.

As shown in FIG. 1C, at a sixth time T6, the testing device 120 may receive the cryptographic signature 126 from the host device 116(2). In some cases, the host device 116(2) may receive the cryptographic signature 126 from a computing device associated with the data store 114. In other cases, the host device 116(2) may receive the cryptographic signature 126 from the host device 116(1), the signing device 104, or from another computing device associated with the system 100. At a seventh time T7, the testing device 120 may generate one or more signed components 128 of the application based on the received cryptographic signature 126, and in some cases, based on one or more of the public cryptographic data 124, other cryptographic data 108(2), or application component(s) 102. The testing device 120 may then install, deploy, execute, or otherwise use the signed component(s) 128 of the application, such as to determine characteristics of performance of the application or testing device 120 under various conditions. The process illustrated in FIGS. 1A-1C may therefore enable the signing device 104 to generate a cryptographic signature 126 for use by the testing device 120 without permitting any computing device other than the signing device 104 to access the private key 106, and without requiring the testing device 120 to transmit application components 102 to other devices. As a result, in some cases, the host devices 116 and data store 114 may be associated with different entities than the signing device 104 and testing device 120 without compromising the security of the private key 106 or application components 102. For example, an entity may maintain a signing network 115 that stores data regarding signing devices 104 and testing devices 120 for multiple other entities, and may determine signing devices 104 having private keys 106 that correspond to requests 122 from each of the entities, without providing private keys 106 or application components 102 to unauthorized devices.

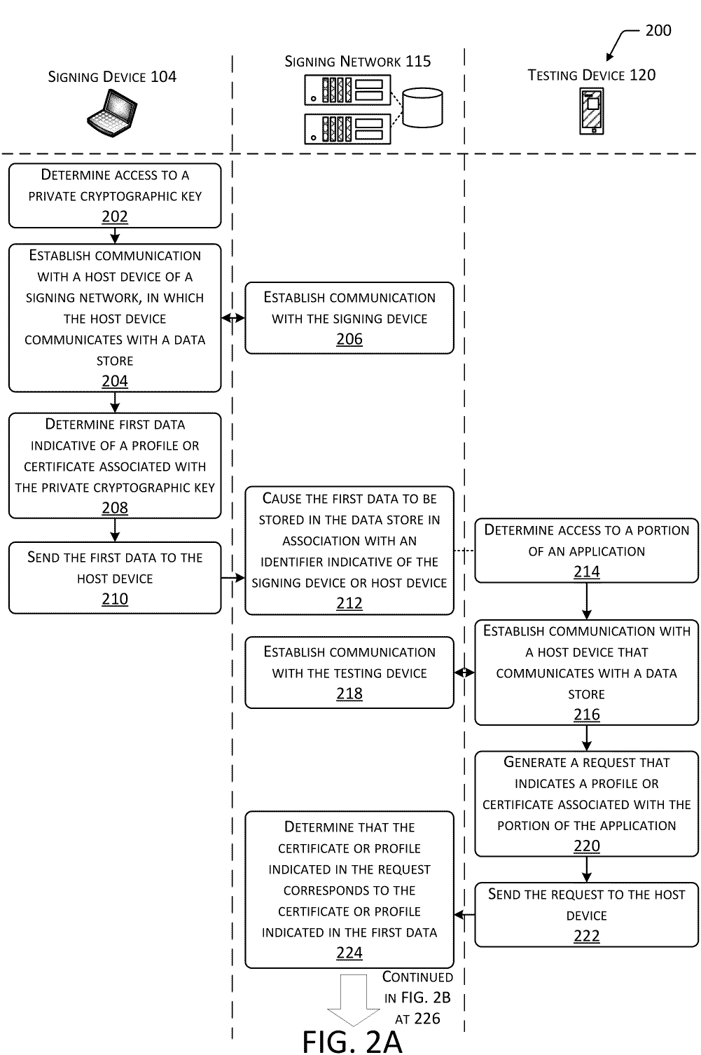

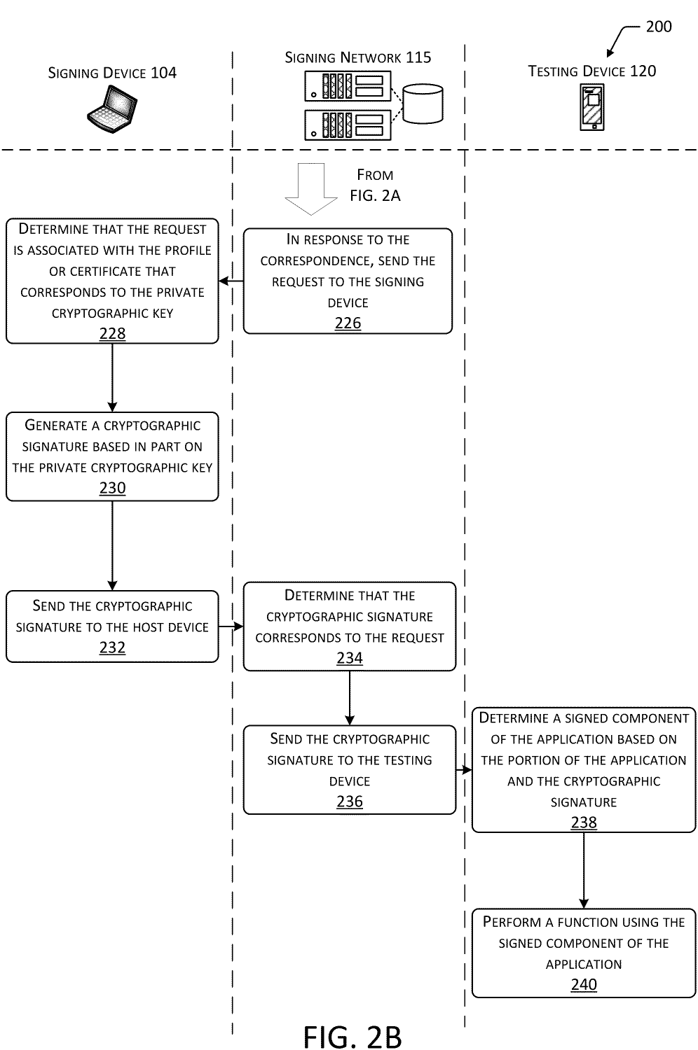

FIGS. 2A and 2B depict an implementation of a process 200 for providing a cryptographic signature 126 from a first device to a second device using a signing network 115 that receives data from the first device and second device. As described with regard to FIGS. 1A-1C, the first device may include a signing device 104, which may provide data indicative of one or more private keys 106 to the signing network 115, while the second device may include a testing device 120 that may provide a request 122 indicative of one or more of a private key 106, public cryptographic data 124, or application components 102 to the signing network 115. The signing network 115 may include one or more computing devices, such as host devices 116 that may establish communication with the signing device 104, testing device 120, and other computing devices, and with computing devices that store or access one or more data stores 114. For example, the signing device 104 and testing device 120 may be associated with an entity responsible for developing, deploying, and debugging an application, but may be located remote from one another. Continuing the example, an entity may maintain testing devices 120 at various geolocations for the purpose of testing performance of the application under network conditions at those geolocations. In other cases, the signing device 104 and testing devices 120 may be associated with different entities. The testing devices 120 may not store the private key 106 and may therefore be unable to generate cryptographic signatures 126 for the application. The signing device 104 may store the private key 106 but may not necessarily store the application component(s) 102 associated with the private key 106. The signing network 115 may include computing devices that may not necessarily be associated with the same entities as the signing device 104 or testing devices 120, but may maintain a data store 114 with information regarding signing devices 104 and testing devices 120. For example, the signing network 115 may receive requests 122 from testing devices 120, determine signing devices 104 that store a private key 106 that corresponds to a request 122, send the request 122 to the signing device 104 for generation of a cryptographic signature 126, and send the cryptographic signature 126 to the testing device 120.

At block 202, the signing device 104 may determine access to a private cryptographic key. The private cryptographic key may be used to generate cryptographic signatures 126 associated with one or more application components 102. The signing device 104 may provide data indicative of the private cryptographic key, such as device data 112, to the signing network 115. As described with regard to FIGS. 1A-1C, in some implementations, the device data 112 may include an indication of a certificate, profile, other cryptographic data 108, or application data 110 that is associated with the private cryptographic key. A data store 114 associated with the signing network 115 may store the data indicative of the private cryptographic key with an identifier indicative of the signing device 104 or another computing device in communication with the signing device 104.

At block 204, the signing device 104 may establish communication with a host device 116 within the signing network 115 that communicates with a data store 114. One example method for establishing communication between the signing device 104 and host device 116 is described with regard to the U.S. Pat. Application having the Application Serial Number 17/179,136, filed Feb. 18, 2021, entitled “Systems for Remote Communication with Test Devices”, incorporated by reference previously.

For example, the signing device 104 may provide a request 122 to access a host device 116 to an Application Programming Interface (API), which may determine host devices 116 that are able to communicate with the signing device 104, and various protocols, communication channels, and other communication characteristics that may be used by the signing device 104 and the determined host devices 116. As shown at block 206, a host device 116 of the signing network 115 may establish communication with the signing device 104. For example, one or more of the host devices 116 may respond to the request 122 with data indicative of various protocols, communication channels, and other communication characteristics that are usable by the host device 116. This data may be used to establish a direct communication channel between the signing device 104 and a host device 116 based on protocols, channels, and other communication characteristics that are usable by both the signing device 104 and the host device 116.

At block 208, the signing device 104 may determine first data indicative of a profile or certificate that is associated with the private cryptographic key. For example, the signing device 104 may store or access a private cryptographic key, and in some implementations, other cryptographic data 108 that corresponds to the private cryptographic key, such as a public key, public certificate, provisioning profile, and so forth. As described with regard to FIGS. 1A-1C, in some implementations, the first data may include device data 112, which may include data indicative of a private key 106, and in some cases, data indicative of the other cryptographic data 108, application data 110, or information regarding the signing device 104.

At block 210, the signing device 104 may send the first data to the host device 116, such as by using the communication channel established at block 204 and block 206. Use of a direct communication channel between the signing device 104 and host device 116 may enable secure communication of the first data.

At block 212, the host device 116 that receives the first data may cause the first data to be stored in a data store 114 in association with an identifier that is indicative of the signing device 104 or the host device 116. For example, as described with regard to FIGS. 1A-1C device data 112 received from a signing device 104 may be stored in association with a device identifier 118 indicative of the signing device 104 or of the host device 116 with which the signing device 104 has established a communication channel. The host device 116 may communicate with one or more other computing devices that store or access the data store 114, or in other implementations, the host device 116 may itself store or access at least a portion of the data store 114.

At block 214, the testing device 120 may determine access to a portion of an application. The portion of the application may include one or more application components 102 for which a cryptographic signature 126 is required to enable the application component(s) 102 to be installed, deployed, executed, or otherwise used. For example, the determined portion of the application may be associated with a particular private cryptographic key, public cryptographic data 124 such as a public key, public certificate, profile, other cryptographic data 108, and so forth.

At block 216, the testing device 120 may establish communication with a host device 116 that communicates with a data store 114. At block 218 the host device 116 of the signing network 115 may establish communication with the testing device 120. The testing device 120 may establish a communication channel with a host device 116 in the same manner described with regard to the signing device 104 at block 204 and block 206.

At block 220, the testing device 120 may generate a request 122 that includes or indicates a profile or certificate associated with the determined portion of the application, and in some cases, that includes data indicative of one or more application components 102. For example, the request 122 may be indicative of a private key 106 associated with an application component 102, the application component 102 itself, or public cryptographic data 124 associated with the application component 102 such as an indication of a public key, public certificate, profile, and so forth.

At block 222, the testing device 120 may send the request 122 to the host device 116, such as by using the communication channel established at block 216 and block 218. Use of a direct communication channel between the testing device 120 and host device 116 may enable secure communication of the request 122.

FIG. 2A depicts block 202 through block 212 vertically above block 214 through block 222, which may indicate that in some implementations, the signing device 104 may establish communication with the signing network 115 and provide the first data to the data store 114 before the testing device 120 provides the request 122. However, in other implementations, the testing device 120 may provide the request 122 to the signing network 115 before the signing device 104 provides the first data, or in other cases, at least partially contemporaneously with the provision of the first data by the signing device 104.

At block 224, a computing device associated with the data store 114 may determine that the certificate or profile indicated in the request 122 provided by the testing device 120 corresponds to the first data provided by the signing device 104. This correspondence may indicate that a private cryptographic key associated with the signing device 104 may be used to generate cryptographic signatures 126 for one or more application components 102 associated with the testing device 120.

As shown in FIG. 2B, at block 226, in response to the correspondence determined at block 224, the request 122 may be sent to the signing device 104. For example, a computing device associated with the data store 114 may determine a host device 116 associated with the device identifier 118 that is stored in association with the first data and may cause the request 122 to be provided to the determined host device 116. The host device 116 may send the request 122 to the signing device 104 using the communication channel established at block 204 and block 206.

At block 228, the signing device 104 may determine that the request 122 is associated with the profile or certificate that corresponds to the private cryptographic key that is stored by or accessible to the signing device 104. At block 230, the signing device 104 may generate a cryptographic signature 126 based in part on the private cryptographic key. In some cases, the cryptographic signature 126 may be generated based on other cryptographic data 108, data associated with an application or component of the application, data included in the request 122, and so forth.

At block 232, the signing device 104 may send the cryptographic signature 126 to the host device 116 with which the signing device 104 established communication in blocks 204 and 206. In some implementations, as shown at block 234, the host device 116 with which the testing device 120 has established communication, or one or more other computing devices associated with the signing network 115, may determine that the cryptographic signature 126 corresponds to the profile, certificate, or other data indicated in the request 122. For example, if the received cryptographic signature 126 does not correspond to the request 122 and is not usable to generate a signed component 128 of the application, the host device 116 may refrain from sending the cryptographic signature 126 to the testing device 120. However, if the cryptographic signature 126 corresponds to the data indicated by the request 122, at block 236, the host device 116 may provide the cryptographic signature 126 to the testing device 120. For example, the data store 114 of the signing network 115 may associate the request 122 with a device identifier 118 indicative of the testing device 120 or indicative of the host device 116 with which the testing device 120 established communication in block 216 and block 218, which may enable the cryptographic signature 126 to be provided to the testing device 120 or associated host device 116. In other implementations, the request 122 or cryptographic signature 126 may include data indicative of the testing device 120 or host device 116.

While FIGS. 2A and 2B depict a single signing device 104 generating a single cryptographic signature 126, in other implementations, multiple signing devices 104 may store or access private keys 106 that correspond to the data in the request 122. In such a case, the signing network 115 may provide the request 122 to multiple signing devices 104, and the host device 116 with which the testing device 120 communicates may receive multiple cryptographic signatures 126. In such a case, the host device 116 may provide the first cryptographic signature 126 received by the host device 116, that is determined to correspond to the request 122, to the testing device 120.

At block 238, the testing device 120 may determine a signed component 128 of the application based on the portion of the application determined at block 214 and the received cryptographic signature 126. For example, a signed component 128 of the application may be generated based on the cryptographic signature 126, one or more application components 102, and in some implementations, public cryptographic data 124 associated with the testing device 120.

At block 240, the testing device 120 may then perform a function using a signed component 128 of the application. For example, the testing device 120 may install one or more components of the application, deploy one or more components of the application to one or more other computing devices, execute or perform one or more functions using the application, such as to acquire test data indicative of performance of the application or testing device 120 under various conditions, and so forth.

While FIGS. 2A and 2B depict the testing device 120 acquiring a single cryptographic signature 126, in some implementations, the testing device 120 may provide requests 122 to acquire multiple cryptographic signatures 126. For example, multiple components of an application may require cryptographic signatures 126 prior to installation, deployment, or use of the components. In some cases, the testing device 120 may provide multiple requests 122 to the signing network 115, and the process described with regard to FIGS. 2A and 2B may be performed to obtain multiple cryptographic signatures 126 at least partially concurrently, such as within a threshold length of time of one another. For example, multiple requests 122 may be sent simultaneously, or a request 122 associated with a second application component 102 may be sent before a cryptographic signature 126 for a previous request 122 associated with a first application component 102 is received. In other implementations, one or more components of an application may depend on one or more other components. For example, a second component of the application may depend on or otherwise be related to a first component. In such a case, the testing device 120 may acquire a cryptographic signature 126 for the first component of an application and generate a signed component 128 before providing a request 122 to the signing network 115 to acquire a cryptographic signature 126 for the second component. In cases where a lack of dependency between multiple components of an application exists, the testing device 120 may provide multiple requests 122 in parallel (e.g., within a threshold length of time of one another), such as at least partially concurrent with one another.

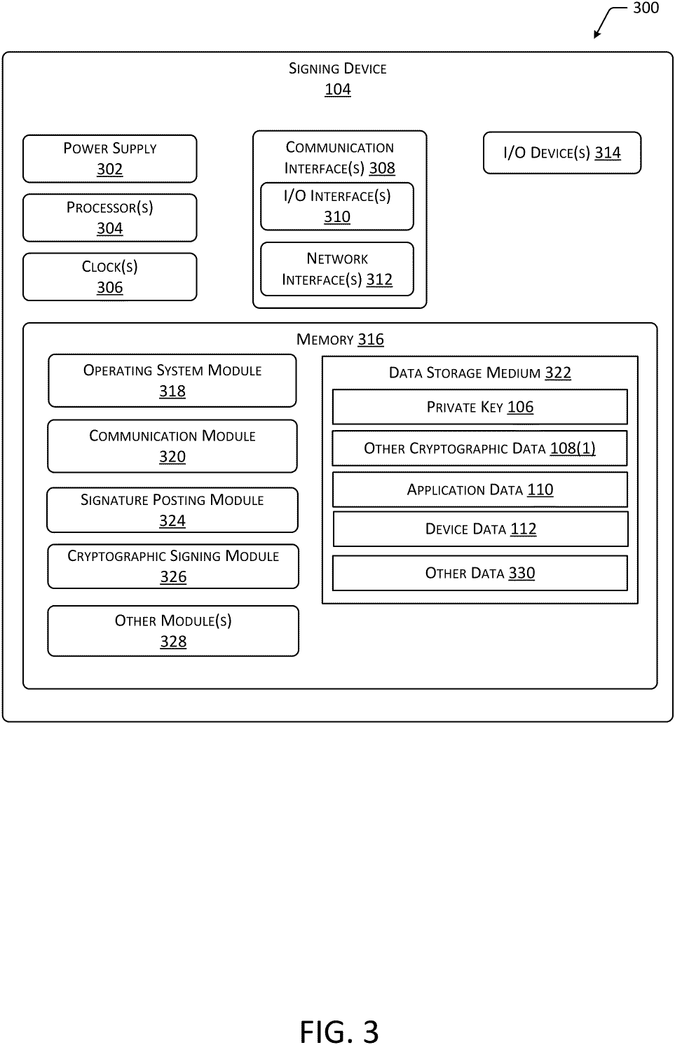

FIG. 3 is a block diagram 300 illustrating an implementation of a signing device 104 within the present disclosure. While FIG. 3 depicts a single block diagram 300, the signing device 104 may include any number and any type of computing devices including, without limitation, personal computing devices, portable computing devices, wearable computing devices, servers, and so forth.

One or more power supplies 302 may be configured to provide electrical power suitable for operating the components of the signing device 104. In some implementations, the power supply 302 may include a rechargeable battery, fuel cell, photovoltaic cell, power conditioning circuitry, and so forth.

The signing device 104 may include one or more hardware processor(s) 304 (processors) configured to execute one or more stored instructions. The processor(s) 304 may include one or more cores. One or more clock(s) 306 may provide information indicative of date, time, ticks, and so forth. For example, the processor(s) 304 may use data from the clock 306 to generate a timestamp, trigger a preprogrammed action, and so forth.

The signing device 104 may include one or more communication interfaces 308, such as input/output (I/O) interfaces 310, network interfaces 312, and so forth. The communication interfaces 308 may enable the signing device 104, or components of the signing device 104, to communicate with other computing devices or components of the other computing devices. The I/O interfaces 310 may include interfaces such as Inter-Integrated Circuit (I2C), Serial Peripheral Interface bus (SPI), Universal Serial Bus (USB) as promulgated by the USB Implementers Forum, RS-232, and so forth.

The I/O interface(s) 310 may couple to one or more I/O devices 314. The I/O devices 314 may include any manner of input devices or output devices associated with the signing device 104. For example, I/O devices 314 may include touch sensors, displays, touch sensors integrated with displays (e.g., touchscreen displays), keyboards, mouse devices, microphones, image sensors, cameras, scanners, speakers or other types of audio output devices, haptic devices, printers, and so forth. In some implementations, the I/O devices 314 may be physically incorporated with the signing device 104. In other implementations, I/O devices 314 may be externally placed.

The network interfaces 312 may be configured to provide communications between the signing device 104 and other devices, such as the I/O devices 314, routers, access points, and so forth. The network interfaces 312 may include devices configured to couple to one or more networks including local area networks (LANs), wireless LANs (WLANs), wide area networks (WANs), wireless WANs, and so forth. For example, the network interfaces 312 may include devices compatible with Ethernet, Wi-Fi, Bluetooth, ZigBee, Z-Wave, 3G, 4G, 5G, LTE, and so forth.

The signing device 104 may include one or more buses or other internal communications hardware or software that allows for the transfer of data between the various modules and components of the signing device 104.

As shown in FIG. 3, the signing device 104 may include one or more memories 316. The memory 316 may include one or more computer-readable storage media (CRSM). The CRSM may be any one or more of an electronic storage medium, a magnetic storage medium, an optical storage medium, a quantum storage medium, a mechanical computer storage medium, and so forth. The memory 316 may provide storage of computer-readable instructions, data structures, program modules, and other data for the operation of the signing device 104. A few example modules are shown stored in the memory 316, although the same functionality may alternatively be implemented in hardware, firmware, or as a system on a chip (SoC). In some implementations, the functionality described with regard to one or more of the modules may be incorporated within a software development kit (SDK), may be performed using one or more Application Programming Interfaces (APIs), and so forth.

The memory 316 may include one or more operating system (OS) modules 318. The OS module 318 may be configured to manage hardware resource devices such as the I/O interfaces 310, the network interfaces 312, the I/O devices 314, and to provide various services to applications or modules executing on the processors 304. The OS module 318 may implement a variant of the FreeBSD operating system as promulgated by the FreeBSD Project; UNIX or a UNIX-like operating system; a variation of the Linux operating system as promulgated by Linus Torvalds; the Windows operating system from Microsoft Corporation of Redmond, Washington, USA; or other operating systems.

The memory 316 may also include a communication module 320, which may be configured to establish communications with one or more other computing devices, such as host devices 116 within a signing network 115. Communications may be authenticated, encrypted, and so forth. In some implementations, communication may be established between computing devices by determining sets of communication parameters, such as protocols, types or formats of data, networks, and routes for transmission of data that may be used by two computing devices when sending or receiving data. For example, implementations by which computing devices may establish communication are described in U.S. Pat. Application 17/179,136, incorporated by reference previously.

One or more data storage media 322 and one or more of the following modules may also be associated with the memory 316. The modules may be executed as foreground applications, background tasks, daemons, and so forth. The data storage media 322 may use a flat file, database, linked list, tree, executable code, script, or other data structure to store information. In some implementations, the data storage media 322 or a portion of the data storage media 322 may be distributed across one or more other devices including other computing devices, network attached storage devices, and so forth.

The memory 316 may also store a signature posting module 324. The signature posting module 324 may determine device data 112 that may be indicative of one or more private keys 106, other cryptographic data 108(1), application data 110, or other data that is stored in association with the signing device 104 or accessible by the signing device 104. For example, the signature posting module 324 may be used to provide device data 112 that is indicative of particular application components 102 for which cryptographic signatures 126 may be generated by the signing device 104, particular private keys 106 stored by or accessible by the signing device 104, or other cryptographic data 108(1) such as public keys, certificates, or profiles associated with a private key 106, and so forth. The device data 112 provided to a data store 114 within the signing network 115 may function as a message indicative of the capabilities of the signing device 104 to generate cryptographic signatures 126. In some implementations, the signature posting module 324 may be configured to periodically or continuously update a status associated with the signing device 104, such as to indicate a continued availability of the signing device 104 to generate cryptographic signatures 126.

The memory 316 may additionally store a cryptographic signing module 326. The cryptographic signing module 326 may generate cryptographic signatures 126 associated with one or more private keys 106 stored by or accessible by the signing device 104. Cryptographic signatures 126 may then be sent to other computing devices, such as to enable a testing device 120 to generate a signed component 128 of an application for use.

Other modules 328 may also be present in the memory 316. For example, other modules 328 may include user interface modules for receiving user input for processing interactions with user interfaces. Other modules 328 may include authorization modules for receiving authorization from users regarding collection, storage, or transmission of data, such as a selection of private keys 106 for which the signing device 104 may be used to generate cryptographic signatures 126, particular devices that are authorized to request generation of a cryptographic signature 126, and so forth. Other modules 328 may further include encryption modules to encrypt and decrypt communications between computing devices, authentication modules to authenticate communications sent or received by computing devices, a permission module to assign, determine, and manage user permissions to access or modify data associated with the signing device 104, and so forth.

Other data 330 within the data storage media 322 may include configurations, settings, preferences, and default values associated with the signing device 104. Other data 322 may also include encryption keys and schema, access credentials, and so forth. Other data 322 may additionally include rules or criteria for determining when to cause devices to perform functions, such as times or a set of conditions that must be met for generation of a cryptographic signature 126 by the signing device 104.

In different implementations, different computing devices may have different capabilities or capacities. For example, servers may have greater processing capabilities or data storage capacity than user devices, such as smartphones or other portable computing devices.

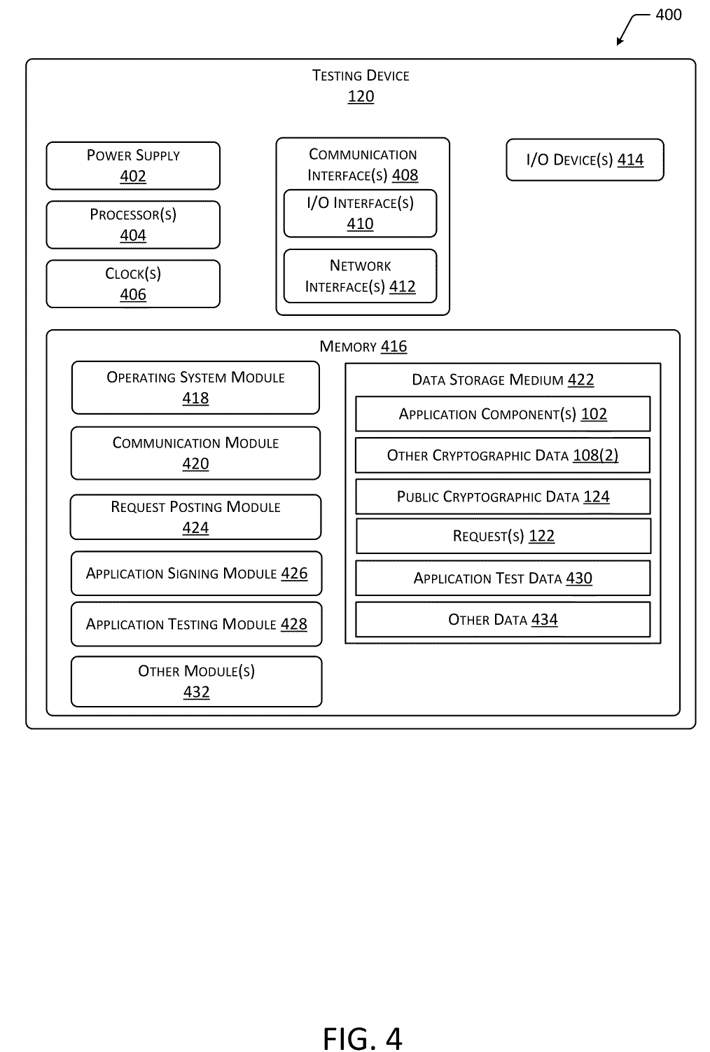

FIG. 4 is a block diagram 400 illustrating an implementation of a testing device 120 within the present disclosure. While FIG. 4 depicts a single block diagram 400, the testing device 120 may include any number and any type of computing devices including, without limitation, the types of computing devices described with regard to the signing device 104.

The testing device 120 is shown including one or more power supplies 402, processors 404, clocks 406, communication interfaces 408, I/O interfaces 410, network interfaces 412, I/O devices 414, and memories 416, which may be similar to the power supplies 302, processors 304, clocks 306, communication interfaces 308, I/O interfaces 310, network interfaces 312, I/O devices 314, and memories 316 described with regard to the signing device 104 shown in FIG. 3.

The memory 416 may include one or more operating system (OS) modules 418 configured to manage hardware resource devices such as the I/O interfaces 410, network interfaces 412, and I/O devices 414, and to provide various services to applications or modules executing on the processors 404.

The memory 416 may also include a communication module 420, which may be configured to establish communications with one or more other computing devices, such as host devices 116 within a signing network 115. Communications may be authenticated, encrypted, and so forth. In some implementations, communication may be established between computing devices by determining sets of communication parameters, such as protocols, types or formats of data, networks, and routes for transmission of data that may be used by two computing devices when sending or receiving data.

One or more data storage media 422 and one or more of the following modules may also be associated with the memory 416. The modules may be executed as foreground applications, background tasks, daemons, and so forth. The data storage media 422 may use a flat file, database, linked list, tree, executable code, script, or other data structure to store information. In some implementations, the data storage media 422 or a portion of the data storage media 422 may be distributed across one or more other devices including other computing devices, network attached storage devices, and so forth.

The memory 416 may also store a request posting module 424. The request posting module 424 may determine one or more requests 122 that may be indicative of one or more application components 102 stored on or accessible by the testing device 120, one or more private keys 106 associated with cryptographic signatures 126 for the application components 102, other cryptographic data 108(2), or other data that is stored in association with the testing device 120 or accessible by the testing device 120. For example, the request posting module 424 may be used to provide one or more requests 122 that are indicative of particular application components 102 for which cryptographic signatures 126 may be needed to install, deploy, execute, or use the application components, particular private keys 106 that may be needed to generate the cryptographic signatures 126, or other cryptographic data 108(2) such as public keys, certificates, or profiles associated with the application components 102, and so forth. The request(s) 122 may be provided to a data store 114 within the signing network 115 and may function as a message or subscription indicative of the capabilities of a signing device 104 to generate cryptographic signatures 126 that may be used in conjunction with the application components 102 of the testing device 120. For example, a signing device 104 that has provided device data 112 to a signing network 115 having characteristics that correspond to the characteristics indicated in a request 122 may be capable of generating a cryptographic signature 126 for use with one or more application components 102 stored in association with the testing device 120.

The memory 416 may additionally store an application signing module 426. The application signing module 426 may generate signed components 128 of applications using cryptographic signatures 126 received from other computing devices, and in some cases using other cryptographic data 108(2), public cryptographic data 124, or application components 102. Generation of signed components 128 may enable the application associated with the testing device 120 to be installed, deployed, executed, or otherwise used.

For example, the memory 416 may store an application testing module 428, which may determine application test data 430 based on use of the application after receiving one or more cryptographic signatures 126 and generating signed components 128. The application testing module 428 may determine one or more conditions or characteristics of the testing device 120, networks accessed by the testing device 120, other computing devices accessed by or that communicate with the testing device 120, the application or components of the application, and so forth. For example, the application test data 430 determined during use of the application may include logs, indications of output presented by the testing device 120, computational resources used by the testing device 120, and so forth.

Other modules 432 may also be present in the memory 416. For example, other modules 432 may include user interface modules for presenting user interfaces and receiving user input, authorization modules for receiving authorization from users regarding collection, storage, or transmission of data, such as acquisition of application test data 430, encryption modules to encrypt and decrypt communications between computing devices, authentication modules to authenticate communications sent or received by computing devices, a permission module to assign, determine, and manage user permissions to access or modify data associated with the testing device 120, and so forth.

Other data 434 within the data storage media 422 may include configurations, settings, preferences, and default values associated with the testing device 120. Other data 422 may also include encryption keys and schema, access credentials, and so forth. Other data 422 may additionally include rules or criteria for determining when to cause devices to perform functions, such as times or a set of conditions that must be met for generation of a request 122, relationships or dependences that exist between application components 102 that may be used to determine an order in which cryptographic signatures 126 are requested, and so forth. For example, if a second component of an application depends on a first component, a request 122 for a cryptographic signature 126 associated with the first component may be generated and sent, and a cryptographic signature 126 received, before sending a request 122 for a cryptographic signature 126 associated with the second component. If a lack of dependency between components exists, then in some implementations, requests 122 for cryptographic signatures 126 associated with multiple components may be sent in parallel.

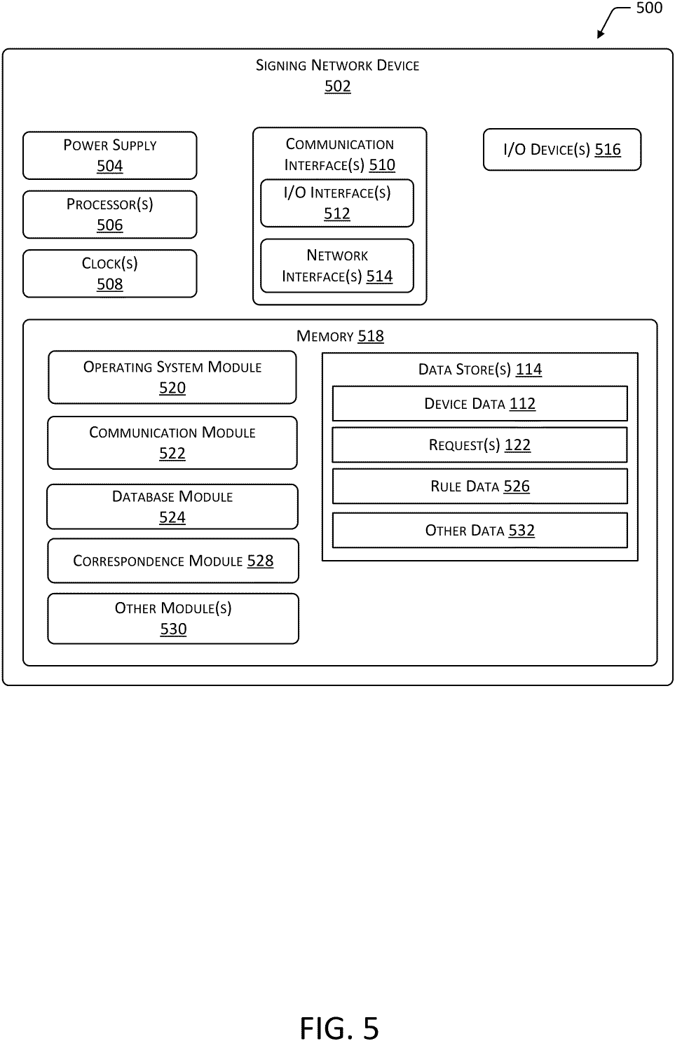

FIG. 5 is a block diagram 500 illustrating an implementation of a signing network device 502 within the present disclosure. The signing network device 502 may include one or more host devices 116, one or more computing devices that store or access one or more data stores 114, or combinations thereof. Therefore, while FIG. 5 depicts a single block diagram 500, any number and any type of computing devices, including without limitation the types of computing devices described with regard to the signing device 104 shown in FIG. 3, may be used.

The signing network device 502 is shown including one or more power supplies 504, processors 506, clocks 508, communication interfaces 510, I/O interfaces 512, network interfaces 514, I/O devices 516, and memories 518, which may be similar to the power supplies 302, processors 304, clocks 306, communication interfaces 308, I/O interfaces 310, network interfaces 312, I/O devices 314, and memories 316 described with regard to the signing device 104 shown in FIG. 3.

The memory 518 may include one or more operating system (OS) modules 520 configured to manage hardware resource devices such as the I/O interfaces 512, network interfaces 514, and I/O devices 516, and to provide various services to applications or modules executing on the processors 506.

The memory 518 may also include a communication module 522, which may be configured to establish communications with one or more other computing devices, such as by managing communications between host devices 116 and computing devices that store or access data stores 114 within the signing network 115, and such as by establishing communications with signing devices 104 and testing devices 120. Communications may be authenticated, encrypted, and so forth. In some implementations, communication may be established between computing devices by determining sets of communication parameters, such as protocols, types or formats of data, networks, and routes for transmission of data that may be used by two computing devices when sending or receiving data.

One or more data stores 114 and one or more of the following modules may also be associated with the memory 518. The modules may be executed as foreground applications, background tasks, daemons, and so forth. The data store(s) 114 may use a flat file, database, linked list, tree, executable code, script, or other data structure to store information. In some implementations, the data store(s) 114 or a portion of the data store(s) 114 may be distributed across one or more other devices including other computing devices, network attached storage devices, and so forth.

The memory 518 may also store a database module 524. The database module 524 may receive device data 112 from signing devices 104, determine device identifiers 118 associated with the signing devices 104, and store the device data 112 in association with the device identifiers 118, such as within a database or other type of data structure. Rule data 526 may be used to control the types of data that are received and processed, the manner in which data is processed and stored, the manner in which data is queried and accessed, and so forth. In a similar manner, the database module 524 may receive requests 122 from testing devices 120, determine device identifiers 118 associated with the testing devices 120, and store requests 122 in association with device identifiers 118.

The memory 518 may additionally store a correspondence module 528. The correspondence module 528 may determine correspondence between a received request 122 and received device data 112. For example, device data 112 received from a signing device 104 may indicate a particular certificate or profile that corresponds to a private key 106. A request 122 received from a testing device 120 may indicate a particular certificate or profile that corresponds to an application component 102. Correspondence between the indicated certificate or profile may indicate that the signing device 104 is capable of generating a cryptographic signature 126 that may be used in association with the application component 102 of the testing device 120. Rule data 526 may include one or more rules for determining correspondence, such as the types of data to be included in the device data 112 and requests 122, the degree to which data may match or otherwise correspond for correspondence to be determined, actions to take in response to determining correspondence, such as providing data indicative of a request 122 to a signing device 104 and providing a received cryptographic signature 126 to a testing device 120, and so forth.

Other modules 530 may also be present in the memory 518. For example, other modules 530 may include user interface modules for presenting user interfaces and receiving user input, authorization modules for receiving authorization from users regarding collection, storage, or transmission of data, encryption modules to encrypt and decrypt communications between computing devices, authentication modules to authenticate communications sent or received by computing devices, a permission module to assign, determine, and manage user permissions to access or modify data such as the rule data 526, and so forth.

Other data 532 within the data store(s) 114 may include configurations, settings, preferences, and default values associated with the signing network device 502. Other data 532 may also include encryption keys and schema, access credentials, and so forth. Other data 532 may additionally include rules or criteria for determining when to cause devices to perform functions, such as times or a set of conditions that must be met for correspondence between a request 122 and device data 112 to be determined, and so forth.

The processes discussed in this disclosure may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures above may be eliminated, combined, or performed in an alternate order. Any steps or operations may be performed serially or in parallel. Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described in this disclosure. The computer-readable storage medium may be one or more of an electronic storage medium, a magnetic storage medium, an optical storage medium, a quantum storage medium, and so forth. For example, the computer-readable storage media may include, but is not limited to, hard drives, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of transitory machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Although certain steps have been described as being performed by certain devices, software programs, processes, or entities, this need not be the case, and a variety of alternative implementations will be understood by those having ordinary skill in the art.

Additionally, those having ordinary skill in the art will readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A system comprising:
a first computing device comprising:
one or more first memories storing first computer-executable instructions; and
one or more first hardware processors to execute the first computer-executable instructions to:
determine a first portion of an application;
generate a first request that indicates one or more of a first profile or a first certificate that is associated with the first portion of the application;
establish communication with a second computing device, wherein the second computing device is in communication with a data store that stores first data indicative of the one or more of the first profile or the first certificate, and wherein the first data is stored in association with a first identifier indicative of a third computing device that provided the first data to the data store;
provide the first request to the second computing device, wherein the second computing device causes the first request to be sent to the third computing device; and
receive, from the second computing device, a first cryptographic signature associated with the first portion of the application, wherein the second computing device receives the first cryptographic signature from the third computing device.

2. The system of claim 1, further comprising:
a fourth computing device comprising:
one or more second memories storing second computer-executable instructions; and
one or more second hardware processors to execute the second computer-executable instructions to:
establish communication with the third computing device;
determine access to a private cryptographic key associated with the one or more of the first profile or the first certificate; and
provide the first data indicative the one or more of the first profile or the first certificate to the third computing device, wherein the third computing device sends the first data to the data store.

3. The system of claim 2, wherein in response to correspondence between the first data and the first request, the first request is sent to the third computing device, the system further comprising second computer-executable instructions to cause the fourth computing device to:
receive the first request from the third computing device, wherein the first request comprises a hash of the first portion of the application;
generate the first cryptographic signature based on the private cryptographic key and the hash value; and
provide the first cryptographic signature to the third computing device, wherein the third computing device causes the first cryptographic signature to be sent to the second computing device.

4. The system of claim 2, wherein the fourth computing device stores the private cryptographic key and generates the first cryptographic signature based at least in part on the private cryptographic key, and wherein the private cryptographic key is accessible only to the fourth computing device.

5. The system of claim 1, further comprising:
second computer-executable instructions in association with the second computing device to cause the second computing device to:
receive the first cryptographic signature from the third computing device;
determine correspondence between the first cryptographic signature and the one or more of the first profile or the first certificate indicated in the first request; and
in response to the correspondence, send the first cryptographic signature to the first computing device.

6. The system of claim 1, further comprising:
first computer-executable instructions to cause the first computing device to:
determine a second portion of the application, wherein the data store stores third data indicative of one or more of a second profile or a second certificate that is associated with the second portion, and the third data is stored in association with one or more of the first identifier or a second identifier indicative of a fourth computing device that provided the third data to the data store;
determine that the second portion is dependent on the first portion;
in response to the first cryptographic signature, generate a second request that indicates of the one or more of the second profile or the second certificate;
provide the second request to the second computing device, wherein the second computing device causes the second request to be sent to one or more of the third computing device or the fourth computing device; and
receive, from the second computing device, a second cryptographic signature associated with the second portion of the application, wherein the second computing device receives the second cryptographic signature from the one or more of the third computing device or the fourth computing device.

7. The system of claim 1, further comprising:
first computer-executable instructions to cause the first computing device to:
determine a second portion of the application;
determine second data indicative of one or more of a second profile or second certificate associated with the second portion, wherein the data store stores an indication of the second data in association with one or more of the first identifier indicative of the third computing device or a second identifier indicative of a fourth computing device that provided the indication of the second data to the data store;
based on a lack of dependency between the second portion and the first portion, provide the indication of the second data the second computing device within a threshold length of time of providing the first data to the second computing device, wherein the second computing device causes the indication of the second data to be sent to one or more of the third computing device or the fourth computing device; and
receive, from the second computing device, a second cryptographic signature associated with the second portion of the application.

8. The system of claim 1, wherein the data store further stores an indication of the one or more of the first profile or the first certificate in association with a second identifier indicative of a fourth computing device, the system further comprising:
second computer-executable instructions in association with the second computing device to cause the second computing device to:
receive the first cryptographic signature from the third computing device;
receive a second cryptographic signature associated with the first portion of the application from the fourth computing device; and
based on the first cryptographic signature corresponding to the first data, and based on the first cryptographic signature being received prior to the second cryptographic signature, send the first cryptographic signature to the first computing device.

9. A system comprising:
a first computing device comprising:
one or more first memories storing first computer-executable instructions; and
one or more first hardware processors to execute the first computer-executable instructions to:
determine access to a private cryptographic key associated with a first portion of an application;
establish communication with a second computing device, wherein the second computing device is in communication with a data store;
determine first data indicative of one or more of a first profile or a first certificate associated with the private cryptographic key;
provide the first data to the second computing device, wherein the second computing device causes the first data to be stored in the data store in association with a first identifier indicative of one or more of the first computing device or the second computing device;
receive a request from the second computing device, wherein the request indicates the one or more of the first profile or the first certificate, and the request was provided to the data store by a third computing device;
determine that the request is associated with the one or more of the first profile or the first certificate;
generate a first cryptographic signature based on the private cryptographic key; and
provide the first cryptographic signature to the second computing device, wherein the second computing device causes the first cryptographic signature to be sent to the third computing device.

10. The system of claim 9, further comprising:
a fourth computing device comprising:
one or more second memories storing the application that includes the first portion and second computer-executable instructions; and
one or more second hardware processors to execute the second computer-executable instructions to:
determine the first portion of the application;
establish communication with the third computing device;
provide the request to the third computing device, wherein the third computing device causes the request to be sent to the second computing device; and
receive, from the third computing device, the first cryptographic signature.

11. The system of claim 10, further comprising:
third computer-executable instructions in association with the third computing device to cause the third computing device to:
receive the first cryptographic signature from the second computing device;
determine correspondence between the first cryptographic signature and the request; and
in response to the correspondence, send the first cryptographic signature to the fourth computing device.

12. The system of claim 9, wherein one or more fourth computing devices provide one or more second requests to the data store, the one or more second requests being indicative of the one or more of the first profile or the first certificate, and in response to correspondence between the first data and the one or more second requests, the one or more second requests are provided to the second computing device, the system further comprising:
first computer executable instructions to cause the first computing device to:
receive the one or more second requests from the second computing device; and
for each request of the one or more second requests: determine that the request is associated with the one or more of the first profile or the first certificate, generate a respective second cryptographic signature based on the private cryptographic key, and provide the respective second cryptographic signature to the second computing device, wherein the second computing device causes the respective second cryptographic signature to be sent to a respective fourth computing device.

13. The system of claim 9, wherein the one or more first memories further store the private cryptographic key that is used to generate the first cryptographic signature, and wherein the private cryptographic key is only accessible to the first computing device.

14. A method comprising:
determining, by a first computing device, access to a private cryptographic key associated with a first portion of an application;
providing, by the first computing device, first data indicative of one or more of a first profile or a first certificate that is associated with the first portion to a data store, wherein the data store stores the first data in association with a first identifier that is associated with the first computing device;
determining, by a second computing device, access to the first portion of the application;
providing, by the second computing device to the data store, a request that indicates the one or more of the first profile or the first certificate;
receiving, by the first computing device, the request;
determining, by the first computing device, that the request is associated with the first portion of the application;
generating, by the first computing device, a first cryptographic signature based on the request and the private cryptographic key;
providing, by the first computing device, access to the first cryptographic signature; and
receiving, by the second computing device, the first cryptographic signature.

15. The method of claim 14, further comprising:
establishing communication between the first computing device and a third computing device, wherein the third computing device:
receives the first data from the first computing device;
provides the first data to the data store;
receives the request;
provides the request to the first computing device;
receives the first cryptographic signature from the first computing device; and
provides access to the first cryptographic signature to the second computing device.

16. The method of claim 15, wherein the private cryptographic key is accessible only by the first computing device.

17. The method of claim 14, further comprising:
establishing communication between the second computing device and a third computing device, wherein the third computing device:
receives the request from the second computing device;
provides the request to the data store;
receives the first cryptographic signature; and
provides the first cryptographic signature to the second computing device.

18. The method of claim 17, wherein the third computing device determines correspondence between the first cryptographic signature and the request, and the first cryptographic signature is provided to the second computing device in response to the correspondence.

19. The method of claim 14, further comprising:
determining, using the second computing device, a signed component of the application based on the first cryptographic signature and the first portion; and
executing the application that includes the signed component.

20. The method of claim 19, wherein the second computing device stores data indicative of one or more of a provisioning profile or a public certificate associated with the first portion of the application, and the signed component is further generated based on the one or more of the provisioning profile or the public certificate.
